(19) United States
(12) Patent Application Publication
(10) Pub. No.: US 2026/0195346 A1
(43) Pub. Date: Jul. 9, 2026

(54) ARTIFICIAL INTELLIGENCE (AI)-BASED SYSTEM FOR ADAPTIVELY CLASSIFYING FILES USING DECENTRALIZED CRYPTOGRAPHIC PROTOCOLS AND METHOD THEREOF

(71) Applicant: SISA Information Security Pvt Ltd, Bengaluru (IN)

(72) Inventor: Aurobinda Patra, Bengaluru (IN)

(21) Appl. No.: 19/281,870

(22) Filed: Jul. 28, 2025

(30) Foreign Application Priority Data
Jan. 7, 2025 (IN) 202541001502

(51) Int. Cl. G06F 16/28; H04L 9/40

(52) U.S. Cl. CPC G06F 16/285; H04L 63/0428

(57) ABSTRACT

An artificial intelligence (AI)-based system for adaptively classifying one or more files using decentralized cryptographic protocols and a method thereof are disclosed. The AI-based system comprises a file-obtaining interface associated with one or more users to obtain the one or more files. The AI-based system comprises a metadata-extraction subsystem, a data encryption subsystem, a data decentralizing subsystem, a decentralizing processing subsystem, a processed data aggregation subsystem, a file classification subsystem, a behavioral analysis subsystem, and a behavior feedback loop subsystem. The AI-based system is configured to extract metadata from the one or more files and encrypt the extracted metadata. The AI-based system disseminates the encrypted metadata to one or more decentralized processing nodes for processing. The process outcome information is analyzed with real-time user activity data, and user feedback data for adaptively classifying each file of the one or more files into one or more categories.

### EARLIEST PRIORITY DATE

This Application claims priority from a Provisional patent application filed in India having Patent Application No. 202541001502, filed on Jan. 7, 2025, and titled “ARTIFICIAL INTELLIGENCE (AI)-BASED SYSTEM FOR ADAPTIVELY CLASSIFYING FILES USING DECENTRALIZED CRYPTOGRAPHIC PROTOCOLS AND METHOD THEREOF”.

### TECHNICAL FIELD

Embodiments of the present disclosure relate to file classification systems and more particularly relate to an artificial intelligence (AI)-based system and an artificial intelligence (AI)-based method for adaptively classifying one or more files using decentralized cryptographic protocols.

### BACKGROUND

In realm of digital information management, file/document classification is crucial for organizing, managing, and securing vast amounts of data in various sectors, including legal, healthcare, and government. Traditional file/document classification systems typically employ static algorithms and predefined rules. The traditional file/document classification systems face significant challenges in adapting to evolving data patterns and protecting sensitive information during the file/document classification process.

The traditional file/document classification systems may not adapt to changing patterns in the data, resulting in decreased accuracy and relevance over time. The traditional file/document classification systems fail to provide adequate security measures for processing one of: sensitive document and proprietary file/document. This deficiency exposes organizations to potential data breaches and privacy violations, which is particularly concerning given the increasing prevalence of cyber threats and stringent data protection regulations. Centralized processing paradigms commonly used in existing systems introduce single points of failure and vulnerabilities to insider threats. These architectural limitations pose significant risks in terms of data security and system reliability.

The dynamic nature of digital content necessitates the traditional file/document classification systems that may learn and adapt to new document types, terminologies, usage patterns, and the like. Adaptability in the traditional file/document classification systems is critical for maintaining high levels of accuracy and efficiency, especially in sectors where the data evolves rapidly, such as legal, healthcare, governmental fields, and the like.

With a cumulative prevalence of cyber threats and stringent data protection regulations, there is a pressing need for file/document classification systems that ensure the confidentiality and integrity of the data throughout the classification process. Traditional methods, which involve the transmission of raw data to centralized servers for processing, present significant risks.

Existing solutions have attempted to address these challenges through various means, including machine learning models for adaptability and encryption techniques for security. However, the existing solutions fall short. The machine learning models require access to the data for classifying, potentially exposing sensitive information. Encryption techniques, while securing the data during transmission, may not protect against the threats at the point of processing.

Secure Multi-Party Computation (SMC) has emerged as a promising cryptographic technique that allows multiple parties to jointly compute a function over inputs while keeping the inputs private. Nevertheless, the integration of the SMC into the file/document classification systems, especially in a manner that supports adaptability and behavior-based analysis, remains underexplored.

In the existing technology, a federal learning execution system is disclosed. The federated learning execution system involves multiple parties in a learning task without revealing private data. However, the federal learning execution may not address the use of behavior-based techniques to adaptively refine the document classification based on user interactions and feedback, which is crucial for maintaining relevance and accuracy in dynamic environments.

In another existing technology, a multi-party collaborative data learning system is disclosed. The multi-party collaborative data learning system employs a combination of active learning and federated learning. While the multi-party collaborative data learning system enhances a learning process using minimal labeled data, the multi-party collaborative data learning system lacks a mechanism for continuous adaptation based on real-time user behavior and document interaction patterns, which are essential for applications in rapidly changing data landscapes.

There are various technical problems with the file classification systems in the prior art. The traditional systems rely on static algorithms and predefined rules, making the file classification systems difficult to adapt to evolving data patterns and new document types. This results in decreased accuracy and relevance over time, particularly in dynamic environments such as legal, healthcare, and governmental sectors. Many existing file classification systems lack robust security measures for processing sensitive or proprietary documents. While some systems employ encryption techniques, these fall short of protecting data at the point of processing. While some file classification systems employ encryption techniques, the file classification systems fall short in protecting data at the point of processing. Additionally, the current file classification systems fail to incorporate user behavior and feedback into their learning processes, missing valuable opportunities for continuous improvement and personalization of classification algorithms.

Therefore, there is a need for an improved file classification system that not only addresses the limitations of adaptability and security found in traditional document classification systems but also leverages the strengths of the SMC to enhance both the functionality and security of the file classification, in order to address the aforementioned issues.

### SUMMARY

This summary is provided to introduce a selection of concepts, in a simple manner, which is further described in the detailed description of the disclosure. This summary is neither intended to identify key or essential inventive concepts of the subject matter nor to determine the scope of the disclosure.

In accordance with an embodiment of the present disclosure, an artificial intelligence (AI)-based system for adaptively classifying one or more files using decentralized cryptographic protocols is disclosed.

According to an embodiment of the present disclosure, the AI-based system comprises a file-obtaining interface and one or more servers. The file-obtaining interface is configured to obtain the one or more files from one or more endpoint devices associated with each user of one or more users to store in one or more databases. The communication between the one or more endpoint devices and the one or more servers is encrypted and digitally signed.

In an embodiment, the one or more servers comprise one or more hardware processors and a memory unit. The memory unit is operatively connected to the one or more hardware processors. The memory unit comprises a set of computer-readable instructions in form of a plurality of subsystems. The plurality of subsystems is configured to be executed by the one or more hardware processors. The plurality of subsystems comprises a metadata-extraction subsystem, a data encryption subsystem, a data decentralizing subsystem, a decentralizing processing subsystem, a processed data aggregation subsystem, a file classification subsystem, a behavioral analysis subsystem, and a behavior feedback loop subsystem.

In another embodiment, the metadata-extraction subsystem is configured to extract metadata associated with at least one of: each file of the one or more files and one or more behavioral patterns of each user of the one or more users, for analyzing the one or more files. The metadata comprises at least one of: content metadata, file properties, behavioral metadata, and contextual metadata. The content metadata comprises at least one of: file content, file structure, key phrases, key terms, and file type, extracted from each file of the one or more files. The file properties comprise at least one of: file name, file generated date, file modified date, file author, file size, file location, file message digest algorithm 5 (MD5), and file hash values. The behavioral metadata comprises at least one of: user interaction data associated with the one or more files, collaboration context data, file access frequency, file access timestamp, and file sharing information. The contextual metadata comprises at least one of: locations of an associated endpoint device of the one or more endpoint devices, user profiles assess information, file version history data. The metadata-extraction subsystem is configured with a natural language processing (NLP) model. The NLP model is configured to analyze the content metadata for detecting sensitive information including at least one of: Personally Identifiable Information (PII), financial data, and contractual terms.

In yet another embodiment, the data encryption subsystem is configured to encrypt the extracted metadata using one or more cryptographic protocols for securing the one or more files at a time of decentralized processing. The one or more cryptographic protocols comprise at least one of: homomorphic encryption protocols, garbled circuit protocols, and oblivious transfer protocols. The homomorphic encryption protocols are configured to enable the decentralizing processing subsystem to process the disseminated metadata by averting a process of decrypting the metadata. The garbled circuit protocols are configured to securely process the disseminated metadata while averting a revelation of information associated with each decentralized processing node of one or more decentralized processing nodes during a secure multi-party computation. The oblivious transfer protocols are configured to enable a first decentralized processing node of the one or more decentralized processing nodes to obtain a piece of encrypted metadata of the disseminated metadata from a second decentralized processing node of the one or more decentralized processing nodes while averting the revelation of information associated with the piece of encrypted metadata.

In another embodiment, the data decentralizing subsystem is configured to disseminate the encrypted metadata to the one or more decentralized processing nodes by using one or more predefined distribution protocols. The one or more predefined distribution protocols comprise at least one of: round-robin, hash-based distribution, and sharding mechanisms.

In yet another embodiment, the decentralizing processing subsystem is configured to process the disseminated metadata in the one or more decentralized processing nodes using at least one of: one or more artificial intelligence (AI) models, and one or more machine learning (ML) models. The decentralizing processing subsystem is configured to process the disseminated metadata based on at least one of: predefined classification conditions, historical behavior patterns, contextual relevance data, and trained classification rules for generating process outcome information.

The at least one of: the one or more artificial intelligence (AI) models, and the one or more machine learning (ML) models comprise at least one of: supervised learning models, reinforcement learning models, and anomaly detection models. The supervised learning models comprise at least one of: naive Bayes, support vector machines (SVM), convolutional neural networks (CNNs), recurrent neural networks (RNNs), and Small Language Models (SLM). The supervised learning models are trained on labeled data and configured to classify one or more files in real-time. The reinforcement learning models comprise a quality(Q)-learning model, the reinforcement learning models are trained on at least one of: the predefined classification conditions, the historical behavior patterns, the contextual relevance data, and trained classification rules, for optimizing adaptive file classification. The anomaly detection models are configured to monitor one or more user activities to detect an abnormal behavior of the one or more users based on the user profiles assess information for triggering one or more alerts.

In another embodiment, the decentralizing processing subsystem comprises a local processing module and a central processing module. The local processing module is configured to process the disseminated metadata in the one or more endpoint devices using at least one of: one or more first artificial intelligence (AI) models within the one or more artificial intelligence (AI) models, and one or more first machine learning (ML) models within the one or more machine learning (ML) models. At least one of: the one or more first AI models, and the one or more first ML models trained on at least one of: the manual classification data of the one or more files, and the user-initiated reclassification actions for adaptively classifying each file of the one or more files. The central processing module is configured to process the disseminated metadata in the one or more servers using at least one of: one or more second AI models within the one or more AI models, and one or more second ML models within the one or more ML models. At least one of: the one or more second AI models, and the one or more second ML models trained at pre-defined time intervals based on aggregated classification metrics data derived from at least one of: the one or more first AI models, and the one or more first ML models.

In yet another embodiment, the processed data aggregation subsystem is configured to receive the processed metadata from the one or more decentralized processing nodes for aggregating the process outcome information associated with each file of the one or more files. The processed data aggregation subsystem is configured to identify the local processing module, and the central processing module based on at least one of: customer identification, client identification, and language identification, to optimize the aggregation and contextual alignment of the process outcome information.

In another embodiment, the file classification subsystem is configured to analyze the aggregated process outcome information with at least one of: real-time user activity data, and user feedback data, for adaptively classifying each file of the one or more files into one or more categories. The behavioral analysis subsystem is operatively connected to the file classification subsystem. The behavioral analysis subsystem is configured to analyze at least one of: the real-time user activity data, and the user feedback data obtained from the one or more users associated with the one or more endpoint devices for optimizing at least one of: the one or more AI models, and the one or more ML models. The real-time user activity data comprises the manual classification data of the one or more files, and the user-initiated reclassification actions. The behavior feedback loop subsystem is operatively connected to the behavioral analysis subsystem and the file classification subsystem. The behavior feedback loop subsystem is configured to continuously update and optimize at least one of: the one or more AI models, and the one or more ML models based on at least one of: the real-time user activity data, and the user feedback data.

In accordance with another embodiment of the present disclosure, an AI-based method for adaptively classifying the one or more files using the decentralized cryptographic protocols. In the first step, the AI-based method includes obtaining, by the file-obtaining interface, the one or more files from the one or more endpoint devices associated with each user of the one or more users to store in the one or more databases. In the next step, the AI-based method includes extracting, by the one or more hardware processors through the metadata-extraction subsystem, the metadata associated with at least one of: each file of the one or more files and the one or more behavioral patterns of each user of the one or more users to analyze the one or more files.

In the next step, the AI-based method includes encrypting, by the one or more hardware processors through the data encryption subsystem, the extracted metadata using the one or more cryptographic protocols for securing the one or more files at the time of decentralized processing. In the next step, the AI-based method includes disseminating, by the one or more hardware processors through the data decentralizing subsystem, the encrypted metadata to the one or more decentralized processing nodes by using the one or more predefined distribution protocols.

In the next step, the AI-based method includes processing, by the one or more hardware processors through the decentralizing processing subsystem, the disseminated metadata in the one or more decentralized processing nodes using at least one of: the one or more AI models, and the one or more ML models based on at least one of: the predefined classification conditions, the historical behavior patterns, the contextual relevance data, and the trained classification rules to generate the process outcome information. In the next step, the AI-based method includes receiving, by the one or more hardware processors through the processed data aggregation subsystem, the processed metadata from the one or more decentralized processing nodes to aggregate the process outcome information associated with each file of the one or more files. In the next step, the AI-based method includes analyzing, by the one or more hardware processors through the file classification subsystem, the aggregated process outcome information with at least one of: real-time user activity data, and user feedback data, for adaptively classifying each file of the one or more files into the one or more categories.

In accordance with another embodiment of the present disclosure, a non-transitory computer-readable storage medium storing computer-executable instructions that, when executed by the one or more hardware processors, cause the one or more hardware processors to perform operations for adaptively classifying one or more files using decentralized cryptographic protocols. The operations comprises: a) obtaining the one or more files from the one or more endpoint devices associated with each user of the one or more users to store in the one or more databases, b) extracting the metadata associated with at least one of: each file of the one or more files and the one or more behavioral patterns of each user of the one or more users to analyze the one or more files, c) encrypting the extracted metadata using the one or more cryptographic protocols for securing the one or more files at the time of decentralized processing, d) disseminating the encrypted metadata to the one or more decentralized processing nodes by using the one or more predefined distribution protocols, e) processing the disseminated metadata in the one or more decentralized processing nodes using at least one of: the one or more one or more AI models, and the one or more ML models based on at least one of: the predefined classification conditions, the historical behavior patterns, the contextual relevance data, and the trained classification rules to generate the process outcome information, f) receiving the processed metadata from the one or more decentralized processing nodes to aggregate the process outcome information associated with each file of the one or more files, and g) analyzing the aggregated process outcome information with at least one of: the real-time user activity data, and the user feedback data, for adaptively classifying each file of the one or more files into the one or more categories.

To further clarify the advantages and features of the present disclosure, a more particular description of the disclosure will follow by reference to specific embodiments thereof, which are illustrated in the appended figures. It is to be appreciated that these figures depict only typical embodiments of the disclosure and are therefore not to be considered limiting in scope. The disclosure will be described and explained with additional specificity and detail with the appended figures.

### BRIEF DESCRIPTION OF DRAWINGS

The disclosure will be described and explained with additional specificity and detail with the accompanying figures in which:

FIG. 1 illustrates an exemplary block diagram representation of a network architecture of an artificial intelligence (AI)-based system for adaptively classifying one or more files using decentralized cryptographic protocols, in accordance with an embodiment of the present disclosure;

FIG. 2A illustrates an exemplary block diagram of the AI-based system as shown in FIG. 1 for adaptively classifying the one or more files using the decentralized cryptographic protocols, in accordance with an embodiment of the present disclosure;

FIG. 2B illustrates an exemplary block diagram of a decentralizing processing subsystem, in accordance with an embodiment of the present disclosure;

FIG. 3 illustrates an exemplary flow chart of an AI-based method for adaptively classifying the one or more files using the decentralized cryptographic protocols, in accordance with an embodiment of the present disclosure; and

FIG. 4 illustrates an exemplary block diagram representation of a server platform for adaptively classifying the one or more files using the decentralized cryptographic protocols, in accordance with an embodiment of the present disclosure.

Further, those skilled in the art will appreciate that elements in the figures are illustrated for simplicity and may not have necessarily been drawn to scale. Furthermore, in terms of the construction of the device, one or more components of the device may have been represented in the figures by conventional symbols, and the figures may show only those specific details that are pertinent to understanding the embodiments of the present disclosure so as not to obscure the figures with details that will be readily apparent to those skilled in the art having the benefit of the description herein.

### DETAILED DESCRIPTION OF THE DISCLOSURE

For the purpose of promoting an understanding of the principles of the disclosure, reference will now be made to the embodiment illustrated in the figures and specific language will be used to describe them. It will nevertheless be understood that no limitation of the scope of the disclosure is thereby intended. Such alterations and further modifications in the illustrated system, and such further applications of the principles of the disclosure as would normally occur to those skilled in the art are to be construed as being within the scope of the present disclosure. It will be understood by those skilled in the art that the foregoing general description and the following detailed description are exemplary and explanatory of the disclosure and are not intended to be restrictive thereof.

In the present document, the word “exemplary” is used herein to mean “serving as an example, instance, or illustration.” Any embodiment or implementation of the present subject matter described herein as “exemplary” is not necessarily to be construed as preferred or advantageous over other embodiments.

The terms “comprise”, “comprising”, or any other variations thereof, are intended to cover a non-exclusive inclusion, such that one or more devices or sub-systems or elements or structures or components preceded by “comprises . . . a“ does not, without more constraints, preclude the existence of other devices, sub-systems, additional sub-modules. Appearances of the phrase ”in an embodiment”, “in another embodiment” and similar language throughout this specification may, but not necessarily do, all refer to the same embodiment.

Unless otherwise defined, all technical and scientific terms used herein have the same meaning as commonly understood by those skilled in the art to which this disclosure belongs. The system, methods, and examples provided herein are only illustrative and not intended to be limiting.

A computer system (standalone, client or server computer system) configured by an application may constitute a “module” (or “subsystem”) that is configured and operated to perform certain operations. In one embodiment, the “module” or “subsystem” may be implemented mechanically or electronically, so a module include dedicated circuitry or logic that is permanently configured (within a special-purpose processor) to perform certain operations. In another embodiment, a “module” or “subsystem” may also comprise programmable logic or circuitry (as encompassed within a general-purpose processor or other programmable processor) that is temporarily configured by software to perform certain operations.

Accordingly, the term “module” or “subsystem” should be understood to encompass a tangible entity, be that an entity that is physically constructed permanently configured (hardwired) or temporarily configured (programmed) to operate in a certain manner and/or to perform certain operations described herein.

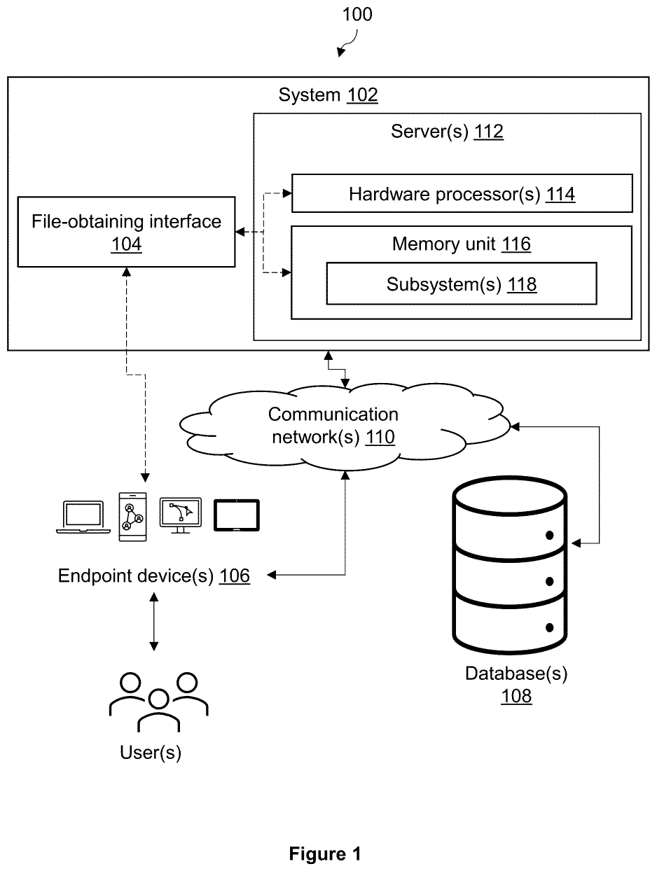

Referring now to the drawings, and more particularly to FIG. 1 through FIG. 4, where similar reference characters denote corresponding features consistently throughout the figures, there are shown preferred embodiments, and these embodiments are described in the context of the following exemplary system and/or method.

FIG. 1 illustrates an exemplary block diagram representation of a network architecture 100 of an artificial intelligence (AI)-based system 102 for adaptively classifying one or more files using decentralized cryptographic protocols, in accordance with an embodiment of the present disclosure.

According to an exemplary embodiment of the present disclosure, the network architecture 100 may include the AI-based system 102, one or more databases 108, and one or more endpoint devices 106. The AI-based system 102, the one or more databases 108, and the one or more endpoint devices 106 may be communicatively coupled via one or more communication networks 110, ensuring seamless data transmission, processing, and decision-making. The AI-based system 102 acts as the central processing unit within the network architecture 100, responsible for adaptively classifying the one or more files using the decentralized cryptographic protocols.

In an exemplary embodiment, each endpoint device 106 of the one or more endpoint devices 106 is configured with a file-obtaining interface 104. The file-obtaining interface 104 is configured to obtain the one or more files from each endpoint device 106 of the one or more endpoint devices 106 associated with each user of one or more users. The one or more files may include documents of varying types, such as, but not limited to, at least one of: text documents, spreadsheets, images, and other file formats that require classification. The one or more files collected by the file-obtaining interface 104 are stored securely in the one or more databases 108 for subsequent analysis and classification within the AI-based system 102.

To maintain data confidentiality and integrity, the communication between the one or more endpoint devices 106 and one or more servers 112 is encrypted and digitally signed. This ensures that all data transmitted between the one or more endpoint devices 106 and the one or more servers 112 remains secure from unauthorized access and tampering during transmission. Encryption guarantees that the files and metadata remain confidential while in transit, while digital signatures authenticate the one or more users, ensuring that the communication originates from a trusted endpoint device 106 within the one or more endpoint devices 106. This level of security is critical in safeguarding sensitive user data, especially when dealing with the one or more files containing personally identifiable information (PII), financial data, and other confidential content.

In an exemplary embodiment, the one or more endpoint devices 106 are configured with a local processing module 222. The local processing module 222 is configured to initially process the one or more files using at least one of: one or more first artificial intelligence (AI) models within one or more artificial intelligence (AI) models, and one or more first machine learning (ML) models within one or more machine learning (ML) models for adaptively classifying the one or more files. Additionally, the one or more endpoint devices 106 are configured to provide the classification results to the one or more uses. The one or more endpoint devices 106 may be digital devices, computing devices, and/or networks. The one or more endpoint devices 106 may include, but not limited to, a mobile device, a smartphone, a personal digital assistant (PDA), a tablet computer, a phablet computer, a wearable computing device, a virtual reality/augmented reality (VR/AR) device, a laptop, a desktop, and the like.

In an exemplary embodiment, the one or more endpoint devices 106 may be associated with, but not limited to, one or more service providers, one or more customers, an individual, an administrator, a vendor, a technician, a specialist, an instructor, a supervisor, a team, an entity, an organization, a company, a facility, a bot, any other user, and combination thereof. The entity, the organization, and the facility may include, but not limited to, an e-commerce company, online marketplaces, service providers, retail stores, a merchant organization, a logistics company, warehouses, transportation company, an airline company, a hotel booking company, a hospital, a healthcare facility, an exercise facility, a laboratory facility, a company, an outlet, a manufacturing unit, an enterprise, an organization, an educational institution, a secured facility, a warehouse facility, a supply chain facility, any other facility/organization and the like.

In an exemplary embodiment, the one or more databases 108 may configured to store, and manage data related to various aspects of the AI-based system 102. The one or more databases 108 may store at least one of: one or more files, metadata associated with each file of the one or more files, feedback data, predefined classification conditions, historical behavior patterns, contextual relevance data, and trained classification rules, classification metrics data, and the like. The one or more databases 108 enable the AI-based system 102 to dynamically retrieve, analyze, and update the stored data in real-time for adaptively classifying one or more files. The one or more databases 108 may include different types of databases such as, but not limited to, relational databases (e.g., Structured Query Language (SQL) databases), non-Structured Query Language (NoSQL) databases (e.g., MongoDB, Cassandra), time-series databases (e.g., InfluxDB), an OpenSearch database, and object storage systems (e.g., Amazon S3, PostgresDB).

In an exemplary embodiment, the one or more communication networks 110 may be, but not limited to, a wired communication network and/or a wireless communication network, a local area network (LAN), a wide area network (WAN), a Wireless Local Area Network (WLAN), a metropolitan area network (MAN), a telephone network, such as the Public Switched Telephone Network (PSTN) or a cellular network, an intranet, the Internet, a fiber optic network, a satellite network, a cloud computing network, or a combination of networks. The wired communication network may comprise, but not limited to, at least one of: Ethernet connections, Fiber Optics, Power Line Communications (PLCs), Serial Communications, Coaxial Cables, Quantum Communication, Advanced Fiber Optics, Hybrid Networks, and the like. The wireless communication network may comprise, but not limited to, at least one of: wireless fidelity (wi-fi), cellular networks (including fourth generation (4G) technologies and fifth generation (5G) technologies), Bluetooth, ZigBee, long-range wide area network (LoRaWAN), satellite communication, radio frequency identification (RFID), 6G (sixth generation) networks, advanced IoT protocols, mesh networks, non-terrestrial networks (NTNs), near field communication (NFC), and the like.

In an exemplary embodiment, the AI-based system 102 comprises the one or more servers 112. The one or more servers 112 may comprise a combination of discrete components, an integrated circuit, an application-specific integrated circuit, a field-programmable gate array, a digital signal processor, or other suitable one or more hardware processors 114 and a software. The “software” may comprise one or more objects, agents, threads, lines of code, subroutines, separate software applications, two or more lines of code, or other suitable software structures operating in one or more software applications or the one or more hardware processors 114. The one or more servers 112 comprises the one or more hardware processors 114 and a memory unit 116. The memory unit 116 is operatively connected to the one or more hardware processors 114. The memory unit 116 comprises a set of computer-readable instructions in form of a plurality of subsystems 118, configured to be executed by the one or more hardware processors 114.

In an exemplary embodiment, the one or more hardware processors 114 may include, for example, microprocessors, microcomputers, microcontrollers, digital signal processors, central processing units, state machines, logic circuits, and/or any devices that manipulate data or signals based on operational instructions. Among other capabilities, the one or more hardware processors 114 may fetch and execute computer-readable instructions in the memory unit 116 operationally coupled with the AI-based system 102 for performing tasks such as data processing, input/output processing, and/or any other functions. Any reference to a task in the present disclosure may refer to an operation being or that may be performed for adaptively classifying the one or more files. The one or more hardware processors 114 is high-performance processors capable of handling large volumes of data and complex computations. The one or more hardware processors 114 may be, but not limited to, at least one of: multi-core central processing units (CPU), graphics processing units (GPUs), and specialized Artificial Intelligence (AI) accelerators that enhance an ability of the AI-based system 102 to process real-time data from one or more sources simultaneously.

In an exemplary embodiment, the AI-based system 102 may be implemented by way of a single device or a combination of multiple devices that may be operatively connected or networked together. The AI-based system 102 may be implemented in hardware or a suitable combination of hardware and software.

Though few components and the plurality of subsystems 118 are disclosed in FIG. 1, there may be additional components and subsystems which is not shown, such as, but not limited to, ports, routers, repeaters, firewall devices, network devices, the one or more databases 108, network attached storage devices, assets, machinery, instruments, facility equipment, emergency management devices, image capturing devices, any other devices, and combination thereof. The person skilled in the art should not be limiting the components/subsystems shown in FIG. 1. Although FIG. 1 illustrates the AI-based system 102, and the one or more endpoint devices 106 connected to the one or more databases 108, one skilled in the art can envision that the AI-based system 102, and the one or more endpoint devices 106 may be connected to several user devices located at various locations and several databases via the one or more communication networks 110.

Those of ordinary skilled in the art will appreciate that the hardware depicted in FIG. 1 may vary for particular implementations. For example, other peripheral devices such as an optical disk drive and the like, the local area network (LAN), the wide area network (WAN), wireless (e.g., wireless-fidelity (Wi-Fi)) adapter, graphics adapter, disk controller, input/output (I/O) adapter also may be used in addition or place of the hardware depicted. The depicted example is provided for explanation only and is not meant to imply architectural limitations concerning the present disclosure.

Those skilled in the art will recognize that, for simplicity and clarity, the full structure and operation of all data processing systems suitable for use with the present disclosure are not being depicted or described herein. Instead, only so much of the AI-based system 102 as is unique to the present disclosure or necessary for an understanding of the present disclosure is depicted and described. The remainder of the construction and operation of the AI-based system 102 may conform to any of the various current implementations and practices that were known in the art.

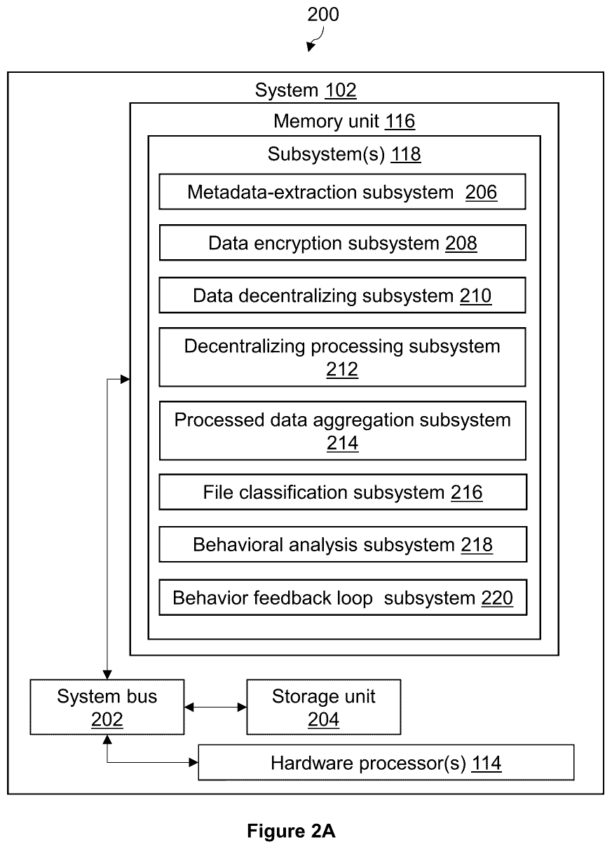

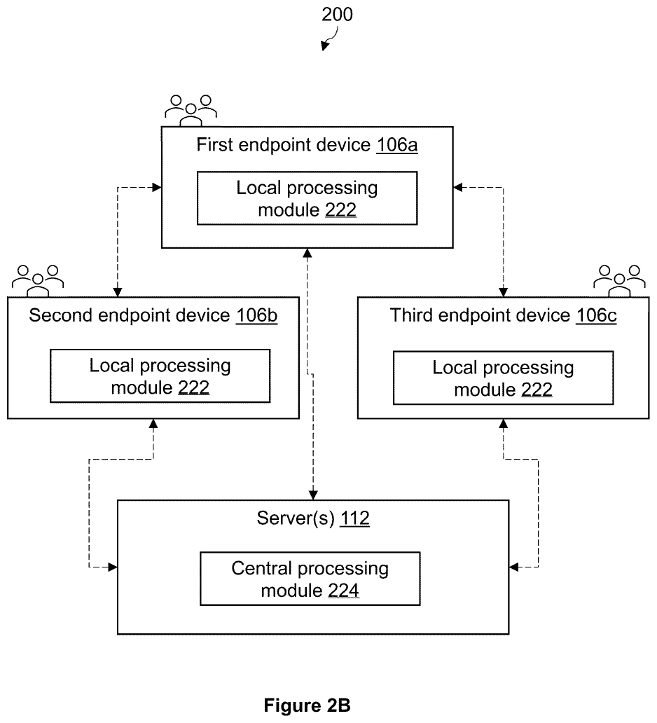

FIG. 2A illustrates an exemplary block diagram 200 of the AI-based system 102 as shown in FIG. 1 for adaptively classifying the one or more files using the decentralized cryptographic protocols, in accordance with an embodiment of the present disclosure.

FIG. 2B illustrates an exemplary block diagram 200 of a decentralizing processing subsystem 212, in accordance with an embodiment of the present disclosure.

In an exemplary embodiment, the AI-based system 102 (hereinafter referred to as the system 102) comprises the one or more servers 112, the memory unit 116, and a storage unit 204. The one or more hardware processors 114, the memory unit 116, and the storage unit 204 are communicatively coupled through a system bus 202 or any similar mechanism. The system bus 202 functions as the central conduit for data transfer and communication between the one or more hardware processors 114, the memory unit 116, and the storage unit 204. The system bus 202 facilitates the efficient exchange of information and instructions, enabling the coordinated operation of the system 102. The system bus 202 may be implemented using various technologies, including but not limited to, parallel buses, serial buses, or high-speed data transfer interfaces such as, but not limited to, at least one of a: universal serial bus (USB), peripheral component interconnect express (PCIe), and similar standards.

In an exemplary embodiment, the memory unit 116 is operatively connected to the one or more hardware processors 114. The memory unit 116 comprises the plurality of subsystems 118 in the form of programmable instructions executable by the one or more hardware processors 114. The plurality of subsystems 118 comprises a metadata-extraction subsystem 206, a data encryption subsystem 208, a data decentralizing subsystem 210, the decentralizing processing subsystem 212, a processed data aggregation subsystem 214, a file classification subsystem 216, a behavioral analysis subsystem 218, and a behavior feedback loop subsystem 220. The one or more hardware processors 114 associated within the one or more servers 112, as used herein, means any type of computational circuit, such as, but not limited to, the microprocessor unit, microcontroller, complex instruction set computing microprocessor unit, reduced instruction set computing microprocessor unit, very long instruction word microprocessor unit, explicitly parallel instruction computing microprocessor unit, graphics processing unit, digital signal processing unit, or any other type of processing circuit. The one or more hardware processors 114 may also include embedded controllers, such as generic or programmable logic devices or arrays, application-specific integrated circuits, single-chip computers, and the like.

The memory unit 116 may be the non-transitory volatile memory and the non-volatile memory. The memory unit 116 may be coupled to communicate with the one or more hardware processors 114, such as being a computer-readable storage medium. The one or more hardware processors 114 may execute machine-readable instructions and/or source code stored in the memory unit 116. A variety of machine-readable instructions may be stored in and accessed from the memory unit 116. The memory unit 116 may include any suitable elements for storing data and machine-readable instructions, such as read-only memory, random access memory, erasable programmable read-only memory, electrically erasable programmable read-only memory, a hard drive, a removable media drive for handling compact disks, digital video disks, diskettes, magnetic tape cartridges, memory cards, and the like. In the present embodiment, the memory unit 116 includes the plurality of subsystems 118 stored in the form of machine-readable instructions on any of the above-mentioned storage media and may be in communication with and executed by the one or more hardware processors 114.

The storage unit 204 may be a cloud storage or the one or more databases 108 such as those shown in FIG. 1. The storage unit 204 may store, but not limited to, recommended course of action sequences dynamically generated by the system 102. These course of action sequences represent a set of optimized instructions or next steps that are the plurality of subsystems 118 to facilitate decision-making and system operation. The dynamically generated action sequences may be used to optimize the evaluation of the system 102, improve response accuracy, enhance security protocols, or adjust the behavior of the system 102 to align with updated requirements or contexts. Additionally, the storage unit 204 may retain previous action sequences for comparison and future reference, enabling continuous refinement of the system 102 over time. The storage unit 204 may be any kind of database such as, but not limited to, relational databases, dedicated databases, dynamic databases, monetized databases, scalable databases, cloud databases, distributed databases, any other databases, and a combination thereof.

In an exemplary embodiment, the metadata-extraction subsystem 206 is configured to extract metadata associated with at least one of: each file of the one or more files and one or more behavioral patterns of each user of the one or more users. The extracted metadata is used for analyzing and categorizing the one or more files, which forms the foundation for the adaptive classification process. The metadata-extraction subsystem 206 is configured to extract metadata directly related to the contents and properties of the one or more files and behavioral data reflecting how users interact with the one or more files, providing insight into potential patterns of use or misuse, which may influence classification decisions.

The extracted metadata encompasses a variety of categories to ensure that all relevant aspects of the one or more files and the one or more behavioral patterns are captured and analyzed comprehensively. The extracted metadata comprises, but not limited to, at least one of: content metadata, file properties, behavioral metadata, contextual metadata, and the like. The content metadata is a type of metadata reflects the internal content structure of the file and plays a key role in determining the one or more files classification. The content metadata comprises, but not limited to, at least one of: a) file content: the actual textual or visual data within the file, b) file structure: the organization of the content, including headings sections, paragraphs, and embedded elements like tables or images, c) key phrases and key terms: specific words or expressions within the file that may indicate sensitive information or a particular document category (e.g., legal terms, medical records, etc.), and d) file type: the format of the file, such as, but not limited to, at least one of: portable document format (pdf), document file extensible markup language(XML) (docx), and Excel Open XML Spreadsheet (xlsx), which may also be indicative of its usage and sensitivity.

The file properties provide fundamental metadata about the creation and modification of the file, allowing the system 102 to track its history and manage its classification accordingly. The file properties comprise, but not limited to, at least one of: a) file name:
the name of the file as stored on the system 102, which may provide insight into its content, b) file generated date and file modified date: these dates support to track the creation and modification history of the one or more files, c) file author: Identifies the creator of the associated file within the one or more files, which can be useful in determining its sensitivity or importance, d) file size: The size of the file, which may impact storage and processing decisions, e) file location: Where the file is stored (local drive, cloud storage, etc.), which is important for access control and data security, f) file Message Digest Algorithm 5 (MD5): A hash function used to verify the integrity of the file by creating a unique hash value, g) file hash values: Cryptographic hash values that serve as digital fingerprints to ensure that the file has not been altered.

The behavioral metadata provides insights into how the one or more users interact with the one or more files. This behavioral metadata facilitates the system 102 adaptively classify the one or more files based on usage patterns and collaborative actions. The behavioral metadata comprises, but not limited to, at least one of: a) user interaction data associated with the one or more files: Tracks how the one or more users view, edit, and interact with the files, b) collaboration context data: Information about how the one or more files are shared and accessed by the one or more users, which may help inform access control and sensitivity levels, d) file access frequency and file access timestamp: These data points track how often and when the one or more files are accessed, which may highlight sensitive or frequently used files, e) file sharing information: Logs of how files are shared (internally or externally), which may inform classification policies related to data leakage prevention.

The contextual metadata provides information about the environment in which the file is accessed or used. The contextual metadata comprises at least one of: a) location of the associated endpoint device 106 of the one or more endpoint devices 106: Tracks the geographical or network location of the associated endpoint device 106 of the one or more endpoint devices 106 accessing the one or more file, which is crucial for detecting anomalous access from unfamiliar locations, b) user profile access information: Data about the user's role, access level, and permissions within the system 102, which influences classification and access controls, c) file version history data: Maintains a record of file changes over time, which is useful for tracking modifications that may affect classification.

In addition to these core metadata categories, the metadata-extraction subsystem 206 is further configured with a Natural Language Processing (NLP) model. The NLP model is a critical component of the system 102 that enhances the capability of the metadata-extraction subsystem 206 by analyzing the content metadata at a deeper level. The NLP model is specifically configured to detect sensitive information embedded within the file content. The metadata-extraction subsystem 206 is configured to recognize and identify patterns that indicate the presence of sensitive data, including but not limited to, PII, the financial data, the contractual terms. The PII contains such as names, social security numbers, addresses, and other personal details that need to be classified and protected to ensure compliance with privacy regulations. The financial data including, but not limited to, bank account numbers, credit card information, and financial statements, are highly sensitive and require strict access control. In the context of the contractual terms: Identifying legally binding terms in documents such as contracts, which must be classified based on their confidentiality and potential legal implications.

In an exemplary embodiment, the data encryption subsystem 208 is configured to encrypt the extracted metadata using one or more cryptographic protocols for securing the one or more files at a time of decentralized processing. This encryption not only safeguards the metadata but also ensures that secure computation can be performed without revealing sensitive information during the processing phases. Given the system's 102 decentralized nature, it is crucial that the data is protected during all stages of transmission and processing.

The one or more cryptographic protocols comprise, but not limited to, at least one of: homomorphic encryption protocols, garbled circuit protocols, oblivious transfer protocols, and the like. The homomorphic encryption protocols are configured to enable the decentralizing processing subsystem 212 to process the disseminated metadata by averting a process of decrypting the metadata. The homomorphic encryption protocols capability is essential in a decentralized environment where data needs to be processed by the one or more decentralized processing nodes while maintaining its confidentiality. This means that the one or more decentralized processing nodes may operate on the encrypted metadata directly, ensuring that the metadata remains protected throughout the computation process. The output of the computation process, when decrypted by an authorized entity, will be the same as if the operations are performed on unencrypted data, thus maintaining the integrity and confidentiality of the metadata during processing.

The garbled circuit protocols are a secure computation protocol used in multi-party computation (MPC), allowing multiple parties to jointly compute a function over their inputs while keeping those inputs confidential. This ensures that no single decentralized processing node, has access to the complete data set. The garbled circuit protocols are configured to securely process the disseminated metadata while averting a revelation of information associated with each decentralized processing node of one or more decentralized processing nodes during a secure multi-party computation. This is achieved during the execution of a secure multi-party computation (SMC), where the garbled circuit allows each decentralized processing node to contribute to the computation without revealing its underlying input data to other decentralized processing nodes or the system 102. This guarantees that the integrity and confidentiality of the metadata are maintained during the entire computation process, even in a decentralized and distributed environment.

The oblivious transfer protocols are cryptographic protocols that ensure secure data exchange between decentralized processing nodes, where one decentralized processing node sends multiple pieces of data but remains unaware of which specific piece of data the receiving decentralized processing node has obtained. The receiving decentralized processing node, in turn, only knows the specific data it requested but learns nothing about the other metadata. The oblivious transfer protocols are configured to enable a first decentralized processing node of the one or more decentralized processing nodes to obtain a piece of encrypted metadata of the disseminated metadata from a second decentralized processing node of the one or more decentralized processing nodes while averting the revelation of information associated with the piece of encrypted metadata. This ensures that the first decentralized processing node is able to retrieve the metadata it needs for computation without learning any other sensitive information held by the second decentralized processing node. The second decentralized processing node, in turn, does not know which piece of metadata the first decentralized processing node has accessed, ensuring mutual confidentiality between the one or more decentralized processing nodes during the metadata exchange. The one or more cryptographic protocols also enable the system 102 to handle sensitive and confidential data while mitigating the risks of unauthorized access, tampering, or data leakage during the SMC. The data encryption subsystem 208 integrates seamlessly with the other subsystems of the system 102, ensuring that the adaptive file classification process is performed securely and efficiently. In an exemplary embodiment, the one or more decentralized processing nodes may be the one or more endpoint devices 106 which are authorized by the system 102 with the digital signature.

In an exemplary embodiment, the data decentralizing subsystem 210 is configured to disseminate the encrypted metadata to the one or more decentralized processing nodes by using one or more predefined distribution protocols. The one or more predefined distribution protocols determine how the encrypted metadata is allocated and managed across the one or more decentralized processing nodes, ensuring that the system 102 operates in a load-balanced, fault-tolerant manner, while maintaining the integrity and confidentiality of the metadata. The one or more predefined distribution protocols comprise, but not limited to, at least one of: round-robin, hash-based distribution, and sharding mechanisms.

The round-robin distribution is used for distributing the metadata evenly across one or more decentralized processing nodes. In round-robin protocol, the metadata is distributed sequentially to each decentralized processing node in a cyclic manner. Once one decentralized processing node receives a piece of metadata, the next piece of metadata is assigned to the following decentralized processing node, and so on, until all nodes in the one or more decentralized processing nodes have received a portion of the metadata. The round-robin ensures that the computational load is evenly spread across all available one or more decentralized processing nodes, preventing any single decentralized processing nodes from becoming a bottleneck. The Round-robin distribution is particularly useful when the one or more decentralized processing nodes have similar processing capabilities, allowing for balanced workloads and efficient resource utilization across the system 102.

The hash-based distribution relies on cryptographic hash functions to determine how the encrypted metadata is allocated to the one or more decentralized processing nodes. In the hash-based distribution, each piece of metadata is passed through a hash function, which generates a unique hash value. This hash value is then used to assign the metadata to a specific decentralized node within the one or more decentralized processing nodes. Hash-based method ensures that metadata is distributed deterministically, meaning that the same metadata may always be assigned to the same decentralized processing node within the one or more decentralized processing nodes. This is particularly useful in scenarios where certain types of metadata need to be processed by specific decentralized processing node based on predefined criteria (e.g., by file type, user behavior, or metadata content).

The sharding mechanisms are a data partitioning technique that involves breaking down large datasets into smaller, manageable pieces called shards, each of which is processed by the one or more decentralized processing nodes. In the sharding mechanisms, the encrypted metadata is divided into multiple shards, with each shard representing a subset of the entire metadata. The shards are then distributed across the one or more decentralized processing nodes for parallel processing.

In an exemplary embodiment, the decentralizing processing subsystem 212 is configured to process the disseminated metadata in the one or more decentralized processing nodes using at least one of: the one or more artificial intelligence (AI) models, and one or more machine learning (ML) models. The decentralizing processing subsystem 212 is configured to process the disseminated metadata based on at least one of: predefined classification conditions, historical behavior patterns, contextual relevance data, and trained classification rules for generating process outcome information. The decentralizing processing subsystem 212 utilizes the predefined classification conditions that have been established based on at least one of: organizational policies, regulatory requirements, and domain-specific rules. The predefined classification conditions serve as a foundation for how the one or more AI models and the one or more ML models operate, providing clear guidelines for the classification of the one or more files. For instance, the one or more files containing specific keywords, phrases, or patterns (such as legal terms, personally identifiable information (PII), or financial data) may be classified as confidential or restricted based on these predefined rules. The one or more AI models and the one or more ML models use these conditions to ensure that the classification process adheres to the organization's security protocols and compliance requirements.

The decentralizing processing subsystem 212 is configured to leverage the historical user behavior data, which is captured and stored as behavioral metadata, to inform future classification decisions. By analyzing how the one or more users have interacted with the one or more files in the past—such as viewing, editing, sharing, or reclassifying files—at least ono of: the one or more AI models and the one or more ML models are able to identify behavioral patterns and use these insights to improve classification accuracy. For instance, if certain types of files are repeatedly accessed by specific users or departments, the system 102 may learn to classify future files with similar characteristics in the same category. This behavior-driven approach enhances the system's 102 ability to adapt to user workflows and preferences.

The contextual metadata provides additional layers of information that are critical for classifying the one or more files. The contextual metadata may include the geographic location of the one or more endpoint device 106 accessing the one or more files, the user's profile and access privileges, and the network or the endpoint device 106 context. By incorporating the contextual relevance data, the system 102 is able to ensure that classification decisions are made based on the current environment. For instance, a specific file accessed from an unfamiliar or untrusted location may be classified with a higher level of sensitivity or restricted access due to potential security risks. Similarly, the system 102 is able to adapt classifications based on user roles—files accessed by legal, or human resources personnel may be classified differently than those accessed by general users.

The trained classification rules are continuously updated based on the system's 102 ability to learn from past classifications by the one or more users, user feedback data, and process outcome information. The trained classification rules are developed through at least one of: the one or more AI models and the one or more ML models, which are trained on large datasets of labeled files. Over time, the system 102 refines the trained classification rules to improve classification accuracy. The one or more decentralized processing nodes apply these trained classification rules to the disseminated metadata to ensure that the one or more files are classified in a manner consistent with historical data, real-time behavior, and predefined policies. This adaptive capability ensures that the system 102 is able to evolve to meet changing organizational needs and user behaviors.

As the one or more decentralized processing nodes apply at least one of: the one or more AI models and the one or more ML models to the metadata based on at least one of: predefined classification conditions, historical behavior patterns, contextual relevance data, and trained classification rules for generating process outcome information. The outcome information represents the classification results for each file and provides insights into how the metadata is analyzed and processed. The process outcome information may include: a) final classification category of the file (e.g., confidential, internal, public), b) any detected anomalies or behavior-based reclassification, c) insights into why the one or more files are classified in a particular way, such as, at least one of: the presence of sensitive keywords, behavioral patterns, contextual factors, and the like.

In an exemplary embodiment, the at least one of: the one or more AI models and the one or more ML models comprise, but not limited to, at least one of: supervised learning models, reinforcement learning models, anomaly detection models, and the like. The supervised learning models comprise at least one of: naive Bayes, support vector machines (SVM), convolutional neural networks (CNNs), recurrent neural networks (RNNs), and Small Language Models (SLM). The supervised learning models are trained on labeled data and configured to classify one or more files in real-time. The reinforcement learning models comprise a quality(Q)-learning model, the reinforcement learning models are trained on at least one of: the predefined classification conditions, the historical behavior patterns, the contextual relevance data, and trained classification rules, for optimizing the adaptive file classification. The anomaly detection models are configured to monitor one or more user activities to detect an abnormal behavior of the one or more users based on the user profiles assess information for triggering one or more alerts.

In an exemplary embodiment, the Naive Bayes is a probabilistic classifier that applies Bayes'theorem to predict the likelihood that a file belongs to a particular classification category based on its metadata. The Naive Bayes is particularly useful for scenarios involving text-based content where key phrases and terms may strongly correlate with sensitive or confidential classifications. The SVM is configured to find an optimal hyperplane to separate the one or more files into different classification categories based on their metadata. The SVM is especially effective in handling high-dimensional data and complex file structures, ensuring accurate classification even when the boundaries between categories are non-linear. The CNN is typically used for image and video processing. The CNNs in the system 102 may be applied to classify the one or more files that contain visual data, such as PDFs with embedded images or scanned documents. The CNN model learns to recognize patterns in file content, such as logos, signatures, or other visual markers that may influence the classification outcome. The RNNs are configured to handle sequential data. The RNNs are able to process the one or more files where the order of the content is important, such as legal contracts or time-series data. The RNNs are capable of identifying patterns in content structure and detecting key terms that might indicate sensitive information over time. The SLM is a lightweight version of language models configured to process and classify textual content in the one or more files. The SLMs are optimized for smaller datasets or environments where computational resources are limited, making them ideal for classifying large volumes of simple text files in real-time. The supervised learning models are configured to classify the one or more files in real-time. The supervised learning models allow the system 102 to provide immediate classification feedback as the one or more files are uploaded, accessed, or modified by the one or more users, ensuring that sensitive or confidential files are correctly classified and appropriately secured without delay.

In addition to supervised learning models, the system 102 employs reinforcement learning models to optimize the classification process over time. These reinforcement learning models are configured to learn from interactions with the environment, continuously improving their classification accuracy based on feedback from the system 102 and the one or more users. The Q-learning model is a type of reinforcement learning algorithm that learns to choose optimal actions by maximizing cumulative rewards over time. In the context of the one or more files classification, the Q-learning models are used to optimize the adaptive classification process by continuously adjusting classification rules based on at least one of: the predefined classification conditions, the historical behavior patterns, the contextual relevance data, the trained classification rules. The reinforcement learning models enable the system 102 to optimize the adaptive file classification process by learning from real-world interactions and continuously improving classification decisions to better align with the one or more user needs and security requirements.

The anomaly detection models monitor user activity to identify unusual or potentially suspicious behavior. The anomaly detection models are configured to track the one or more user interactions with the one or more files, such as viewing, editing, sharing, and reclassifying, to establish a baseline of normal behavior. By comparing current one or more user activities with the historical behavior patterns and predefined norms, the anomaly detection models are able to detect deviations that may signal a potential security threat. For example, if a user typically only accesses internal documents but suddenly downloads several confidential files, the anomaly detection model may flag this as unusual behavior. The system 102 uses user profiles assess information such as access permissions, user roles, and past behavior, to refine its analysis and trigger one or more alerts when abnormal activities are detected. When an anomaly is detected, the system 102 is configured to trigger the one or more alerts, notifying administrators or taking predefined actions, such as restricting access to the affected one or more files or prompting a reclassification review.

In an exemplary embodiment, the decentralizing processing subsystem 212 comprises the local processing module 222 and a central processing module 224. The local processing module 222 is configured to process the disseminated metadata in the one or more endpoint devices 106 using at least one of: one or more first AI models within the one or more AI models, and one or more first ML models within the one or more ML models. At least one of: the one or more first AI models, and the one or more first ML models trained on at least one of: the manual classification data of the one or more files, and the user-initiated reclassification actions for adaptively classifying each file of the one or more files. The central processing module 224 is configured to process the disseminated metadata in the one or more servers 112 using at least one of: one or more second AI models within the one or more AI models, and one or more second ML models within the one or more ML models. At least one of: the one or more second AI models, and the one or more second ML models trained at pre-defined time intervals based on aggregated classification metrics data derived from at least one of: the one or more first AI models, and the one or more first ML models.

For instance, Employee A accesses a financial report in a first endpoint device 106a. As soon as the file is opened, the local processing module 222 on the first endpoint device 106a immediately processes the file's metadata using at least one of: the one or more first AI models and the one or more ML models. At least one of: the one or more first AI models and the one or more ML models are already trained on data like manual classification data (e.g., how other financial reports have been classified) and user-initiated reclassification actions (e.g., how similar documents/files are reclassified in the past). Similarly, the same process is adopted on other endpoint devices like a second endpoint device 106b, a third endpoint device 106c, and the like.

The local processing module 222 quickly classifies the file as “confidential finance” based on predefined classification rules (e.g., keywords like “profit”, “revenue”, “forecast” trigger a financial classification). This real-time classification ensures that the file is secured immediately, restricting unauthorized sharing or copying without any delay. If the Employee A edits the files, the local processing module 222 continuously monitors the changes, re-evaluating the classification if necessary. For example, if the Employee A adds sensitive financial figures or the PII, the local processing module 222 may automatically upgrade the classification to “Highly Confidential”. The file is classified on the first endpoint device 106a before any further interaction, ensuring immediate security and compliance with organizational policies without requiring centralized intervention.

Further, an aggregated analysis and at least one of: the one or more AI models and the one or more ML models refinement based on data from multiple users across the organization. At the end of the pre-defined interval, the central processing module 224, located on the one or more servers 112, aggregates classification data from multiple employees, including Employee A's financial report and hundreds of other documents processed across the first endpoint device 106a, the second endpoint device 106b, the third endpoint device 106c and the like. At least one of: the one or more second AI models and the one or more second ML models in the central processing module 224 are trained at pre-defined intervals (e.g., nightly or weekly) based on the classification outcomes and feedback from the local processing modules 222. At least one of: the one or more second AI models and the one or more second ML models analyze aggregated classification metrics, which include patterns observed in metadata, user behavior, and reclassification events across the entire organization.

For instance, the central processing module 224 identifies that multiple financial documents have been reclassified by the one or more users from “Confidential” to “Highly Confidential” after financial forecasts are added. Based on this pattern, the central processing module 224 updates the classification rules, adjusting the least one of: the one or more second AI models and the one or more second ML models to automatically classify similar documents as “Highly Confidential” in the future, reducing the need for manual reclassification. Additionally, the central processing module 224 may detect anomalies or new trends in how the one or more files are being accessed or classified. For example, if a significant number of files classified as “Public” are being accessed from unusual locations, the central processing module 224 may flag this for further review or recommend adjustments to access policies. The central processing module 224 ensures that the system 102 continuously improves by refining classification rules and models based on aggregated data, optimizing the organization's file classification practices across the one or more users and the one or more endpoint devices 106.

In an exemplary embodiment, the decentralized processing subsystem 212 is further configured to apply a federated learning model to the metadata distributed across the one or more decentralized processing nodes, enabling the system 102 to collaboratively update at least one of: the one or more AI models and the one or more ML models based on local data while preserving data privacy at each node.

In an exemplary embodiment, the processed data aggregation subsystem 214 is configured to receive the processed metadata from the one or more decentralized processing nodes for aggregating the process outcome information associated with each file of the one or more files. The processed data aggregation subsystem 214 is configured to identify the local processing module 222, and the central processing module 224 based on at least one of:
customer identification, client identification, and language identification, to optimize the aggregation and contextual alignment of the process outcome information. The processed data aggregation subsystem 214 is configured with a consensus mechanism. The consensus mechanism is configured to verify the accuracy and consistency of the processed metadata received from the one or more decentralized processing nodes before aggregating the process outcome information, thereby ensuring the integrity of the classification results. Further, the processed data aggregation subsystem 214 is configured implement a redundancy check to ensure that all decentralized processing nodes with the one or more decentralized processing nodes have completed their assigned processes before final aggregation, thereby ensuring comprehensive and accurate classification results.

In an exemplary embodiment, the file classification subsystem 216 operates in conjunction with the behavioral analysis subsystem 218 and the behavior feedback loop subsystem 220 to provide an adaptive and dynamic classification of the one or more files. The file classification subsystem 216 is configured to analyze the aggregated process outcome information with at least one of: real-time user activity data, and user feedback data, for adaptively classifying each file of the one or more files into one or more categories. The real-time user activity data includes how the one or more users interact with the classified one or more files on a day-to-day basis, such as file access, modification, sharing, and other actions. The user feedback data includes manual reclassification or direct feedback provided by the one or more users who interact with the system 102, reflecting how they perceive the classification accuracy or relevance. By analyzing this combined data, the file classification subsystem 216 adaptively classifies each file into one or more categories, such as “Public,” “Confidential,” or “Highly Confidential.” The adaptive approach ensures that classification decisions evolve based on real-time user behavior and ongoing feedback from the one or more users, making the system 102 responsive to changes in how the one or more files are used or perceived by the one or more users.

In an exemplary embodiment, the behavioral analysis subsystem 218 operates as an intelligent layer connected to the file classification subsystem 216, responsible for analyzing user behavior in order to optimize the classification. The behavioral analysis subsystem 218 is operatively connected to the file classification subsystem 216. The behavioral analysis subsystem 218 is configured to analyze at least one of: the real-time user activity data, and the user feedback data obtained from the one or more users associated with the one or more endpoint devices 106 for optimizing at least one of: the one or more AI models, and the one or more ML models. The real-time user activity data comprises the manual classification data of the one or more files, and the user-initiated reclassification actions. When the one or more users manually classify the one or more files, this data is captured and fed back into at least one of: the one or more AI models and the one or more ML models, to refine future classification decisions. When the one or more users reclassify the one or more files after an initial automated classification, this action serves as valuable feedback to the system 102, helping at least one of: the one or more AI models and the one or more ML models, to learn from the manual adjustments made by the one or more users. Over time, at least one of: the one or more AI models and the one or more ML models become more aligned with the one or more users expectations and organizational policies.

The behavior feedback loop subsystem 220 is operatively connected to the behavioral analysis subsystem 218 and the file classification subsystem 216. The behavior feedback loop subsystem 220 is configured to continuously update and optimize at least one of: the one or more AI models, and the one or more ML models based on at least one of: the real-time user activity data, and the user feedback data.

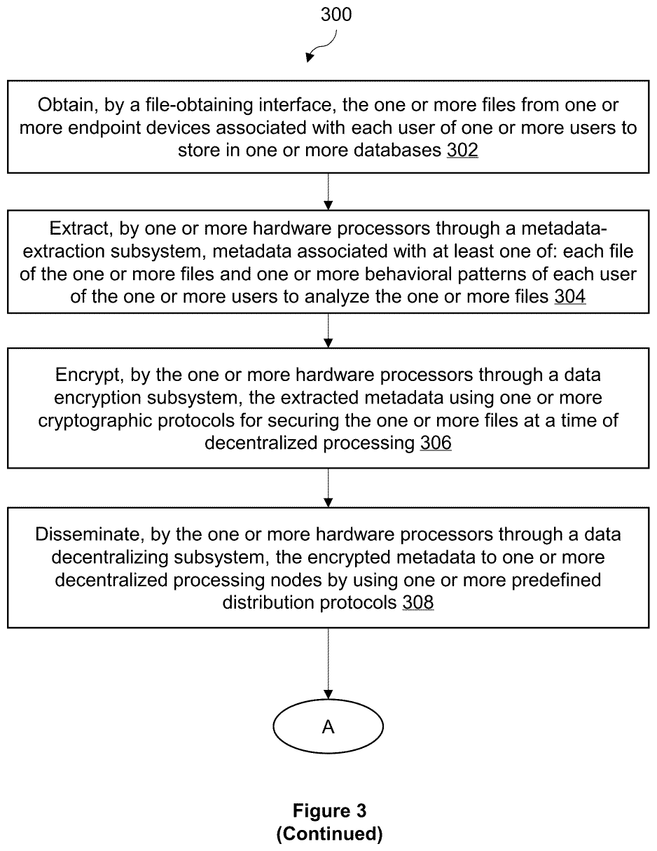

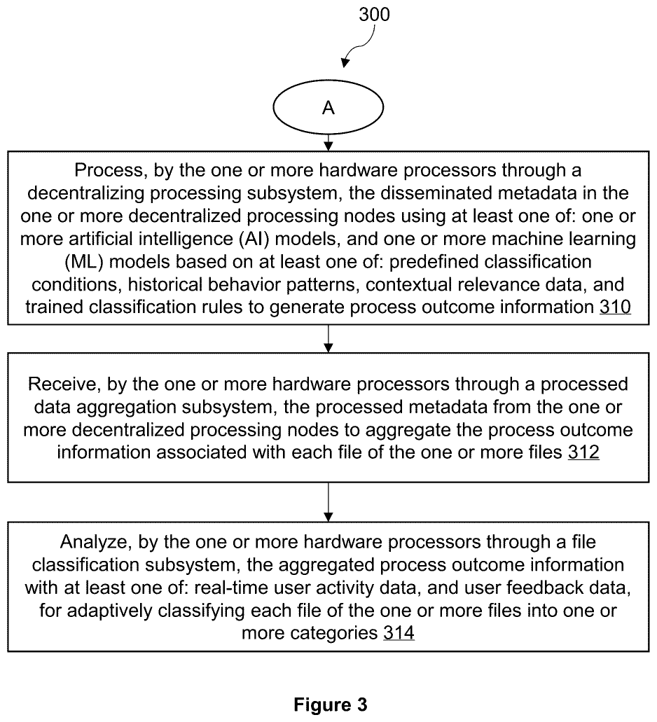

FIG. 3 illustrates an exemplary flow chart of an AI-based method 300 for adaptively classifying the one or more files using the decentralized cryptographic protocols, in accordance with an embodiment of the present disclosure.

According to an exemplary embodiment of the present disclosure, the AI-based method 300 for adaptively classifying the one or more files using the decentralized cryptographic protocols is disclosed. At step 302, the AI-based method 300 includes obtaining, by the file-obtaining interface, the one or more files from the one or more endpoint devices associated with each user of the one or more users to store in the one or more databases. The communication between the one or more endpoint devices and the one or more servers is encrypted and digitally signed. At step 304, the AI-based method 300 includes extracting, by the one or more hardware processors through the metadata-extraction subsystem, the metadata associated with at least one of: each file of the one or more files and the one or more behavioral patterns of each user of the one or more users to analyze the one or more files. The metadata comprises at least one of: the content metadata, the file properties, the behavioral metadata, and the contextual metadata. The AI-based method 300 includes extracting the metadata comprises analyzing, by the NLP model, the content metadata for detecting sensitive information including at least one of: the PII, the financial data, and the contractual terms.

At step 306, the AI-based method 300 includes encrypting, by the one or more hardware processors through the data encryption subsystem, the extracted metadata using the one or more cryptographic protocols for securing the one or more files at the time of decentralized processing. The one or more cryptographic protocols comprises at least one of: the homomorphic encryption protocols, the garbled circuit protocols, and the oblivious transfer protocols. The homomorphic encryption protocols allow computation to be performed on encrypted data without decrypting it. This is crucial in scenarios where parties need to perform collaborative classification or anomaly detection on encrypted behavioral data or file content. The garbled circuit protocols (Yao's Protocol) are used for secure function evaluation in the system. The garbled circuit protocols allows two endpoint devices to jointly compute a function without revealing their private inputs to each other. The oblivious transfer protocols are used in conjunction with the garbled circuit protocols to ensure that one endpoint device with in the one or more endpoint devices is able to obtain data from another endpoint device with in the one or more endpoint devices without revealing which piece of data was selected.

The At step 308, the AI-based method 300 includes disseminating, by the one or more hardware processors through the data decentralizing subsystem, the encrypted metadata to the one or more decentralized processing nodes by using the one or more predefined distribution protocols. The one or more predefined distribution protocols comprise at least one of: the round-robin, the hash-based distribution, the sharding mechanisms, and the like.

At step 310, the AI-based method 300 includes processing, by the one or more hardware processors through the decentralizing processing subsystem, the disseminated metadata in the one or more decentralized processing nodes using at least one of: the one or more AI models, and the one or more ML models based on at least one of: the predefined classification conditions, the historical behavior patterns, the contextual relevance data, and the trained classification rules to generate the process outcome information. At least one of: the one or more AI models, and the one or more ML models comprises at least one of: the supervised learning models, the reinforcement learning models, the anomaly detection models, and the like. Further, the AI-based method 300 includes processing the disseminated metadata comprises a) processing, by the local processing module, the disseminated metadata in the one or more endpoint devices using at least one of: the one or more first AI models, and one or more first ML models. Additionally, the AI-based method 300 includes processing, by the central processing module, the disseminated metadata in the one or more servers using at least one of: one or more second AI models, and one or more second ML models.

At step 312, the AI-based method 300 includes receiving, by the one or more hardware processors through the processed data aggregation subsystem, the processed metadata from the one or more decentralized processing nodes to aggregate the process outcome information associated with each file of the one or more files.

At step 314, the AI-based method 300 includes analyzing, by the one or more hardware processors through the file classification subsystem, the aggregated process outcome information with at least one of: real-time user activity data, and user feedback data, for adaptively classifying each file of the one or more files into the one or more categories. In the next step, the AI-based method 300 includes analyzing, by the one or more hardware processors through the behavioral analysis subsystem, at least one of: the real-time user activity data, and the user feedback data obtained from the one or more users associated with the one or more endpoint devices for optimizing at least one of: the one or more AI models, and the one or more ML models. The real-time user activity data comprises the manual classification data of the one or more files, and the user-initiated reclassification actions. In the next step, the AI-based method 300 includes updating, by the one or more hardware processors through the behavior feedback loop subsystem, at least one of: the one or more AI models, and the one or more ML models for optimizing, based on at least one of: the real-time user activity data, and the user feedback data.

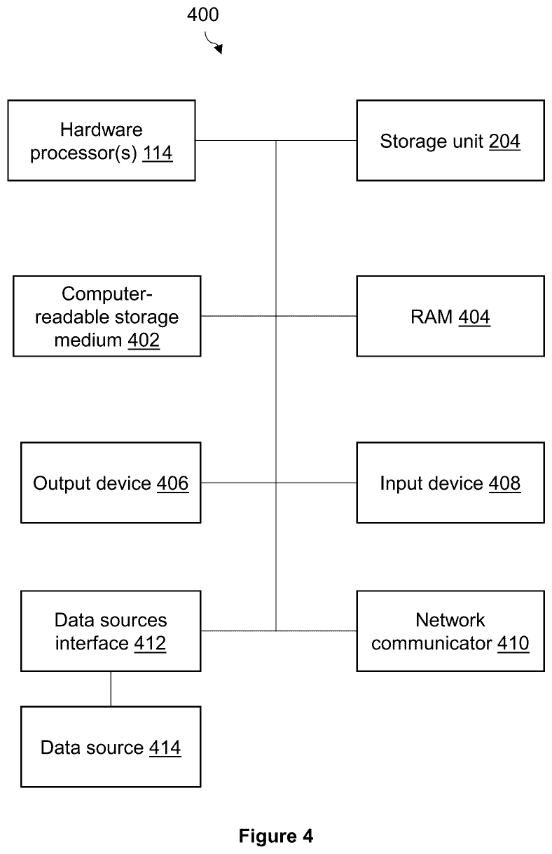

FIG. 4 illustrates an exemplary block diagram representation of a server platform 400 for adaptively classifying the one or more files using the decentralized cryptographic protocols, in accordance with an embodiment of the present disclosure.

In an exemplary embodiment, for the sake of brevity, the construction, and operational features of the system 102 which are explained in detail above are not explained in detail herein. Particularly, computing machines such as but not limited to internal/external server clusters, quantum computers, desktops, laptops, smartphones, tablets, and wearables may be used to execute the system 102 or may include the structure of one or more server platforms 400. As illustrated, the one or more server platforms 400 may include additional components not shown, and some of the components described may be removed and/or modified. For example, a computer system with the multiple graphics processing units (GPUs) may be located on at least one of: internal printed circuit boards (PCBs) and external-cloud platforms including Amazon Web Services (AWS), Google Cloud Platform (GCP) Microsoft Azure (Azure), internal corporate cloud computing clusters, or organizational computing resources.

The one or more server platforms 400 may be a computer system such as the system 102 that may be used with the embodiments described herein. The computer system may represent a computational platform that includes components that may be in the one or more servers 112 or another computer system. The computer system may be executed by the one or more hardware processors 114 (e.g., single, or multiple processors) or other hardware processing circuits, the methods, functions, and other processes described herein. These methods, functions, and other processes may be embodied as machine-readable instructions stored on a computer-readable medium, which may be non-transitory, such as hardware storage devices (e.g., RAM (random access memory), ROM (read-only memory), EPROM (erasable, programmable ROM), EEPROM (electrically erasable, programmable ROM), hard drives, and flash memory). The computer system may include the one or more hardware processors 114 that execute software instructions or code stored on a non-transitory computer-readable storage medium 402 to perform methods of the present disclosure. The software code includes, for example, instructions to gather data and analyze the network environment data. For example, the plurality of subsystems 118 includes the metadata-extraction subsystem 206, the data encryption subsystem 208, the data decentralizing subsystem 210, the decentralizing processing subsystem 212, the processed data aggregation subsystem 214, the file classification subsystem 216, the behavioral analysis subsystem 218, and the behavior feedback loop subsystem 220.

The instructions on the computer-readable storage medium 402 are read and stored the instructions in the storage unit 204 or random-access memory (RAM) 404. The storage unit 204 may provide a space for keeping static data where at least some instructions could be stored for later execution. The stored instructions may be further compiled to generate other representations of the instructions and dynamically stored in the RAM 404. The one or more hardware processors 114 may read instructions from the RAM 404 and perform actions as instructed.

The computer system may further include an output device 406 to provide at least some of the results of the execution as output including, but not limited to, visual information of the performance reports to the one or more users. The output device 406 may include a display on computing devices and virtual reality glasses. For example, the display may be a mobile phone screen or a laptop screen. GUIs and/or text may be presented as an output on the display screen. The computer system may further include an input device 408 to provide the one or more users or another device with mechanisms for input the one or more files and/or otherwise interacting with the computer system. The input device 408 may include, for example, a keyboard, a keypad, a mouse, or a touchscreen. Each of the output devices 406 and the input device 408 may be joined by one or more additional peripherals.

A network communicator 410 may be provided to connect the computer system to a network and in turn to other devices connected to the network including other entities, servers, data stores, and interfaces. The network communicator 410 may include, for example, a network adapter such as a LAN adapter or a wireless adapter. The computer system may include a data sources interface 412 to access a data source 414. The data source 414 may be an information resource about the one or more generative AI models. As an example, the one or more databases 108 of exceptions and rules may be provided as the data source 414. Moreover, knowledge repositories and curated data may be other examples of the data source 414. The data source 414 may include libraries containing, but not limited to, datasets related to the predefined classification conditions, the historical behavior patterns, the contextual relevance data, the file version history data, user profiles assess information, the manual classification data of the one or more files, and the user-initiated reclassification actions. Moreover, the data sources interface 412 enables the system 102 to dynamically access and update these data repositories as new information is collected, analyzed, and utilized.

Numerous advantages of the present disclosure may be apparent from the discussion above. In accordance with the present disclosure, the system for adaptively classifying the one or more files using the decentralized cryptographic protocols. The system uses decentralized cryptographic protocols, which ensure that sensitive metadata and the one or more files remain encrypted throughout the classification stages. The encryption prevents unauthorized access or tampering, even during the distributed processing across the one or more decentralized processing nodes. By averting the need to decrypt metadata during computation, the system significantly reduces the risk of data breaches. The system enables real-time classification of the one or more files by processing at the one or more endpoint devices through the local processing module. This ensures that the one or more files are classified as soon as they are accessed or modified, allowing for immediate enforcement of security policies and access restrictions. The one or more users are provided with instant feedback on the classification status of their files, minimizing delays and increasing overall workflow efficiency.

The integration of at least one of: the one or more AI models and the one or more ML models, along with the behavior feedback loop subsystem, allows the system to continuously learn from real-time user activity and user feedback data. This adaptability ensures that classification rules evolve over time, based on user behavior and organizational changes. The system optimizes at least one of: the one or more AI models and the one or more ML models based on historical data, user reclassifications, and manual feedback, leading to increasingly accurate and context-aware classifications.

By utilizing a decentralized processing architecture, the system distributes computational tasks across multiple decentralized nodes. This enables the system to handle large volumes of data and files without overloading any single processing unit. The central processing module handles more complex tasks, while the local processing module ensures immediate file classification at the one or more endpoint devices. This distributed approach enhances scalability, allowing the system to efficiently manage growing data sets and user bases.

The decentralized nature of the system provides fault tolerance and redundancy. If the one or more decentralized processing nodes fail or become unavailable, the system may continue processing the remaining tasks using other available one or more decentralized processing nodes. This ensures that the system remains operational even in the face of network failures or hardware malfunctions, maintaining uninterrupted classification services. The system integrates contextual metadata and behavioral metadata to provide more nuanced and accurate classifications. By analyzing factors such as user profiles, file access patterns, location, and collaboration context, the system adapts its classification decisions based on the specific circumstances under which files are accessed or modified. This context-aware approach ensures that the one or more files are classified appropriately based on real-world usage scenarios.

The system's ability to detect and classify the one or more files containing Personally Identifiable Information (PII), financial data, and contractual terms ensures that sensitive information is handled in compliance with data privacy regulations such as General Data Protection Regulation (GDPR), Health Insurance Portability and Accountability Act (HIPAA), and Central Consumer Protection Authority (CCPA). The system automates the classification of sensitive data, reducing the risk of non-compliance and improving data governance practices within the organization. By employing advanced the one or more AI models and the one or more ML models for adaptive classification, the system reduces the need for manual classification by the one or more users. As the the one or more AI models and the one or more ML models continuously improve based on user feedback and behavior, the system becomes increasingly capable of automatically classifying the one or more files with minimal human intervention. This reduces the workload on employees, allowing them to focus on higher-value tasks while the system handles routine classification duties.

The system provides a streamlined approach to file management by automatically categorizing files into predefined categories (e.g., Confidential, Public, Internal). This organizational structure simplifies file retrieval, storage, and sharing while ensuring that the one or more files are stored in accordance with their sensitivity level. The adaptive nature of the system ensures that files are reclassified as their content or context changes over time. The system is configured to be compatible with existing Information Technology (IT) infrastructures, including cloud-based storage solutions and on-premise servers. This flexibility allows the one or more users to integrate the system into their current workflows without significant disruption or costly infrastructure overhauls. The system's ability to process data both locally (at the one or more endpoint devices) and centrally (on the one or more servers 112) ensures seamless operation across different network environments.

A description of an embodiment with several components in communication with each other does not imply that all such components are required. On the contrary, a variety of optional components are described to illustrate the wide variety of possible embodiments of the invention. When a single device or article is described herein, it will be apparent that more than one device/article (whether or not they cooperate) may be used in place of a single device/article. Similarly, where more than one device or article is described herein (whether or not they cooperate), it will be apparent that a single device/article may be used in place of the more than one device or article, or a different number of devices/articles may be used instead of the shown number of devices or programs. The functionality and/or the features of a device may be alternatively embodied by one or more other devices which are not explicitly described as having such functionality/features. Thus, other embodiments of the invention need not include the device itself.

The illustrated steps are set out to explain the exemplary embodiments shown, and it should be anticipated that ongoing technological development will change the manner in which particular functions are performed. These examples are presented herein for purposes of illustration, and not limitation. Further, the boundaries of the functional building blocks have been arbitrarily defined herein for the convenience of the description. Alternative boundaries can be defined so long as the specified functions and relationships thereof are appropriately performed. Alternatives (including equivalents, extensions, variations, deviations, etc., of those described herein) will be apparent to persons skilled in the relevant art(s) based on the teachings contained herein. Such alternatives fall within the scope and spirit of the disclosed embodiments. Also, the words “comprising,” “having,” “containing,” and “including,” and other similar forms are intended to be equivalent in meaning and be open-ended in that an item or items following any one of these words is not meant to be an exhaustive listing of such item or items or meant to be limited to only the listed item or items. It must also be noted that as used herein and in the appended claims, the singular forms “a,” “an,” and “the” include plural references unless the context clearly dictates otherwise.

Finally, the language used in the specification has been principally selected for readability and instructional purposes, and it may not have been selected to delineate or circumscribe the inventive subject matter. It is therefore intended that the scope of the invention be limited not by this detailed description, but rather by any claims that issue on an application based here on. Accordingly, the embodiments of the present invention are intended to be illustrative, but not limiting, of the scope of the invention, which is set forth in the following claims.

What is claimed is:

1. An artificial intelligence (AI)-based system for adaptively classifying one or more files using decentralized cryptographic protocols, comprising:
a file-obtaining interface configured to obtain the one or more files from one or more endpoint devices associated with each user of one or more users to store in one or more databases;
one or more servers, comprising:
one or more hardware processors; and
a memory unit operatively connected to the one or more hardware processors, wherein the memory unit comprises a set of computer-readable instructions in form of a plurality of subsystems, configured to be executed by the one or more hardware processors, wherein the plurality of subsystems comprises:
a metadata-extraction subsystem configured to extract metadata associated with at least one of: each file of the one or more files and one or more behavioral patterns of each user of the one or more users, for analyzing the one or more files;
a data encryption subsystem configured to encrypt the extracted metadata using one or more cryptographic protocols for securing the one or more files at a time of decentralized processing;
a data decentralizing subsystem configured to disseminate the encrypted metadata to one or more decentralized processing nodes by using one or more predefined distribution protocols;
a decentralizing processing subsystem configured to process the disseminated metadata in the one or more decentralized processing nodes using at least one of: one or more artificial intelligence (AI) models, and one or more machine learning (ML) models based on at least one of: predefined classification conditions, historical behavior patterns, contextual relevance data, and trained classification rules for generating process outcome information;
a processed data aggregation subsystem configured to receive the processed metadata from the one or more decentralized processing nodes for aggregating the process outcome information associated with each file of the one or more files; and
a file classification subsystem configured to analyze the aggregated process outcome information with at least one of: real-time user activity data, and user feedback data, for adaptively classifying each file of the one or more files into one or more categories.

2. The artificial intelligence (AI)-based system of claim 1, wherein communication between the one or more endpoint devices and the one or more servers is encrypted and digitally signed.

3. The artificial intelligence (AI)-based system of claim 1, wherein the metadata comprises at least one of: content metadata, file properties, behavioral metadata, and contextual metadata,
the content metadata comprises at least one of: file content, file structure, key phrases, key terms, and file type, extracted from each file of the one or more files;
the file properties comprise at least one of: file name, file generated date, file modified date, file author, file size, file location, file message digest algorithm 5 (MD5), and file hash values;
the behavioral metadata comprises at least one of: user interaction data associated with the one or more files, collaboration context data, file access frequency, file access timestamp, and file sharing information; and
the contextual metadata comprises at least one of: locations of an associated endpoint device of the one or more endpoint devices, user profiles assess information, file version history data.

4. The artificial intelligence (AI)-based system of claim 1, wherein the metadata-extraction subsystem is configured with a natural language processing (NLP) model,
the natural language processing (NLP) model is configured to analyze the content metadata for detecting sensitive information including at least one of: Personally Identifiable Information (PII), financial data, and contractual terms.

5. The artificial intelligence (AI)-based system of claim 1, wherein the one or more cryptographic protocols comprise at least one of: homomorphic encryption protocols, garbled circuit protocols, and oblivious transfer protocols,
the homomorphic encryption protocols are configured to enable the decentralizing processing subsystem to process the disseminated metadata by averting a process of decrypting the metadata;
the garbled circuit protocols are configured to securely process the disseminated metadata while averting a revelation of information associated with each decentralized processing node of the one or more decentralized processing nodes during a secure multi-party computation; and
the oblivious transfer protocols are configured to enable a first decentralized processing node of the one or more decentralized processing nodes to obtain a piece of encrypted metadata of the disseminated metadata from a second decentralized processing node of the one or more decentralized processing nodes while averting the revelation of information associated with the piece of encrypted metadata.

6. The artificial intelligence (AI)-based system of claim 1, wherein the one or more predefined distribution protocols comprise at least one of: round-robin, hash-based distribution, and sharding mechanisms.

7. The artificial intelligence (AI)-based system of claim 1, wherein at least one of: the one or more artificial intelligence (AI) models, and the one or more machine learning (ML) models comprise at least one of: supervised learning models, reinforcement learning models, and anomaly detection models,
the supervised learning models comprise at least one of: naive bayes, support vector machines (SVM), convolutional neural networks (CNNs), recurrent neural networks (RNNs), and Small Language Models (SLM), wherein the supervised learning models are trained on labeled data and configured to classify one or more files in real-time;
the reinforcement learning models comprise a quality(Q)-learning model, the reinforcement learning models are trained on at least one of: the predefined classification conditions, the historical behavior patterns, the contextual relevance data, and trained classification rules, for optimizing the adaptive file classification; and
the anomaly detection models are configured to monitor one or more user activities to detect an abnormal behavior of the one or more users based on the user profiles assess information for triggering one or more alerts.

8. The artificial intelligence (AI)-based system of claim 1, wherein the plurality of subsystems further comprises:
a behavioral analysis subsystem operatively connected to the file classification subsystem, configured to analyze at least one of: the real-time user activity data, and the user feedback data obtained from the one or more users associated with the one or more endpoint devices for optimizing at least one of: the one or more artificial intelligence (AI) models, and the one or more machine learning (ML) models,
the real-time user activity data comprises manual classification data of the one or more files, and user-initiated reclassification actions; and
a behavior feedback loop subsystem operatively connected to the behavioral analysis subsystem and the file classification subsystem, configured to continuously update and optimize at least one of: the one or more artificial intelligence (AI) models, and the one or more machine learning (ML) models based on at least one of: the real-time user activity data, and the user feedback data.

9. The artificial intelligence (AI)-based system of claim 1, wherein the decentralizing processing subsystem comprises a local processing module and a central processing module,
the local processing module is configured to process the disseminated metadata in the one or more endpoint devices using at least one of: one or more first artificial intelligence (AI) models within the one or more artificial intelligence (AI) models, and one or more first machine learning (ML) models within the one or more machine learning (ML) models,
at least one of: the one or more first artificial intelligence (AI) models, and the one or more first machine learning (ML) models trained on at least one of: the manual classification data of the one or more files, and the user-initiated reclassification actions for adaptively classifying each file of the one or more files; and
the central processing module is configured to process the disseminated metadata in the one or more servers using at least one of: one or more second artificial intelligence (AI) models within the one or more artificial intelligence (AI) models, and one or more second machine learning (ML) models within the one or more machine learning (ML) models,
at least one of: the one or more second artificial intelligence (AI) models, and the one or more second machine learning (ML) models trained at pre-defined time intervals based on aggregated classification metrics data derived from at least one of: the one or more first artificial intelligence (AI) models, and the one or more first machine learning (ML) models.

10. The artificial intelligence (AI)-based system of claim 1, wherein the processed data aggregation subsystem is configured to identify the local processing module and the central processing module based on at least one of: customer identification, client identification, and language identification, to optimize the aggregation and contextual alignment of the process outcome information.

11. An artificial intelligence (AI)-based method for adaptively classifying one or more files using decentralized cryptographic protocols, comprising:
obtaining, by a file-obtaining interface, the one or more files from one or more endpoint devices associated with each user of one or more users to store in one or more databases;
extracting, by one or more hardware processors through a metadata-extraction subsystem, metadata associated with at least one of: each file of the one or more files and one or more behavioral patterns of each user of the one or more users to analyze the one or more files;
encrypting, by the one or more hardware processors through a data encryption subsystem, the extracted metadata using one or more cryptographic protocols for securing the one or more files at a time of decentralized processing;
disseminating, by the one or more hardware processors through a data decentralizing subsystem, the encrypted metadata to one or more decentralized processing nodes by using one or more predefined distribution protocols;
processing, by the one or more hardware processors through a decentralizing processing subsystem, the disseminated metadata in the one or more decentralized processing nodes using at least one of: one or more artificial intelligence (AI) models, and one or more machine learning (ML) models based on at least one of: predefined classification conditions, historical behavior patterns, contextual relevance data, and trained classification rules to generate process outcome information;
receiving, by the one or more hardware processors through a processed data aggregation subsystem, the processed metadata from the one or more decentralized processing nodes to aggregate the process outcome information associated with each file of the one or more files;
and analyzing, by the one or more hardware processors through a file classification subsystem, the aggregated process outcome information with at least one of: real-time user activity data, and user feedback data, for adaptively classifying each file of the one or more files into one or more categories.

12. The artificial intelligence (AI)-based method of claim 11, wherein communication between the one or more endpoint devices and one or more servers is encrypted and digitally signed.

13. The artificial intelligence (AI)-based method of claim 11, wherein the metadata comprises at least one of: content metadata, file properties, behavioral metadata, and contextual metadata,
the content metadata comprises at least one of: file content, file structure, key phrases, key terms, and file type, extracted from each file of the one or more files;
the file properties comprises at least one of: file name, file generated date, file modified date, file author, file size, file location, file message digest algorithm 5 (MD5), and file hash values;
the behavioral metadata comprises at least one of: user interaction data associated with the one or more files, collaboration context data, file access frequency, file access timestamp, and file sharing information; and
the contextual metadata comprises at least one of: location of an associated endpoint device of the one or more endpoint devices, user profiles assess information, file version history data.

14. The artificial intelligence (AI)-based method of claim 11, wherein extracting the metadata comprises:
analyzing, by a natural language processing (NLP) model, the content metadata for detecting sensitive information including at least one of: Personally Identifiable Information (PII), financial data, and contractual terms.

15. The artificial intelligence (AI)-based method of claim 11, wherein the one or more cryptographic protocols comprises at least one of: homomorphic encryption protocols, garbled circuit protocols, and oblivious transfer protocols,
the homomorphic encryption protocols are configured to enable the decentralizing processing subsystem to process the disseminated metadata by averting a process of decrypting the metadata;
the garbled circuit protocols are configured to securely process the disseminated metadata while averting a revelation of information associated with each decentralized processing node of the one or more decentralized processing nodes during a secure multi-party computation; and
the oblivious transfer protocols are configured to enable a first decentralized processing node of the one or more decentralized processing nodes to obtain a piece of encrypted metadata of the disseminated metadata from a second decentralized processing node of the one or more decentralized processing nodes while averting the revelation of information associated with the piece of encrypted metadata.

16. The artificial intelligence (AI)-based method of claim 11, wherein at least one of: the one or more artificial intelligence (AI) models, and the one or more machine learning (ML) models comprises at least one of: supervised learning models, reinforcement learning models, and anomaly detection models,
the supervised learning models comprise at least one of: naive bayes, support vector machines (SVM), convolutional neural networks (CNNs), recurrent neural networks (RNNs), and Small Language Models (SLM), wherein the supervised learning models are trained on labeled data and configured to classify one or more files in real-time;
the reinforcement learning models comprise a quality(Q)-learning model, the reinforcement learning models are trained on at least one of: the predefined classification conditions, the historical behavior patterns, the contextual relevance data, and trained classification rules, for optimizing the adaptive file classification; and
the anomaly detection models are configured to monitor one or more user activities to detect an abnormal behavior of the one or more users based on the user profiles assess information for triggering one or more alerts.

17. The artificial intelligence (AI)-based method of claim 11, further comprising:
analyzing, by the one or more hardware processors through a behavioral analysis subsystem, at least one of: the real-time user activity data, and the user feedback data obtained from the one or more users associated with the one or more endpoint devices for optimizing at least one of: the one or more artificial intelligence (AI) models, and the one or more machine learning (ML) models;
the real-time user activity data comprises manual classification data of the one or more files, and user-initiated reclassification actions; and
updating, by the one or more hardware processors through a behavior feedback loop subsystem, at least one of: the one or more artificial intelligence (AI) models, and the one or more machine learning (ML) models for optimizing, based on at least one of: the real-time user activity data, and the user feedback data.

18. The artificial intelligence (AI)-based method of claim 11, wherein processing the disseminated metadata comprises:
processing, by a local processing module, the disseminated metadata in the one or more endpoint devices using at least one of: one or more first artificial intelligence (AI) models, and one or more first machine learning (ML) models,
at least one of: the one or more first artificial intelligence (AI) models, and the one or more first machine learning (ML) models trained on at least one of: the manual classification data of the one or more files, and the user-initiated reclassification actions for adaptively classifying each file of the one or more files; and
processing, by a central processing module, the disseminated metadata in the one or more servers using at least one of: one or more second artificial intelligence (AI) models, and one or more second machine learning (ML) models,
at least one of: the one or more second artificial intelligence (AI) models, and the one or more second machine learning (ML) models trained at pre-defined time intervals based on aggregated classification metrics data derived from at least one of: the one or more first artificial intelligence (AI) models, and the one or more first machine learning (ML) models.

19. A non-transitory computer-readable storage medium storing computer-executable instructions that, when executed by one or more hardware processors, cause the one or more hardware processors to perform operations for adaptively classifying one or more files using decentralized cryptographic protocols, the operations comprising:
obtaining the one or more files from one or more endpoint devices associated with each user of one or more users to store in one or more databases;
extracting metadata associated with at least one of: each file of the one or more files and one or more behavioral patterns of each user of the one or more users to analyze the one or more files;
encrypting the extracted metadata using one or more cryptographic protocols for securing the one or more files at a time of decentralized processing;
disseminating the encrypted metadata to one or more decentralized processing nodes by using one or more predefined distribution protocols;
processing the disseminated metadata in the one or more decentralized processing nodes using at least one of: one or more artificial intelligence (AI) models, and one or more machine learning (ML) models based on at least one of: predefined classification conditions, historical behavior patterns, contextual relevance data, and trained classification rules to generate process outcome information;
receiving the processed metadata from the one or more decentralized processing nodes to aggregate the process outcome information associated with each file of the one or more files; and
analyzing the aggregated process outcome information with at least one of: real-time user activity data, and user feedback data, for adaptively classifying each file of the one or more files into one or more categories.

20. The non-transitory computer-readable storage medium of claim 19, further comprising:
analyzing, by the one or more hardware processors through a behavioral analysis subsystem, at least one of: the real-time user activity data, and the user feedback data obtained from the one or more users associated with the one or more endpoint devices for optimizing at least one of: the one or more artificial intelligence (AI) models, and the one or more machine learning (ML) models;
the real-time user activity data comprises manual classification data of the one or more files, and user-initiated reclassification actions; and
updating, by the one or more hardware processors through a behavior feedback loop subsystem, at least one of: the one or more artificial intelligence (AI) models, and the one or more machine learning (ML) models for optimizing, based on at least one of: the real-time user activity data, and the user feedback data.
